(19) United States
(12) Patent Application Publication
(10) Pub. No.: US 2014/0165700 A1
(43) Pub. Date: Jun. 19, 2014

(54) Method of diagnosing on increased risk of alzheimer's disease

(71) Applicants: Matej Oresic, Espoo (FI); Hilkka Soininen, Kuopio (FI); Tuulia Hyotylainen, Espoo (FI)

(72) Inventors: Matej Oresic, Espoo (FI); Hilkka Soininen, Kuopio (FI); Tuulia Hyotylainen, Espoo (FI)

(73) Assignees: ITA-SUOMEN YLIOPISTO, Kuopio (FI); TEKNOLOGIAN TUTKIMUSKESKUS VTT, VTT (FI)

(21) Appl. No.: 14/125,091

(22) PCT Filed: Jun. 8, 2012
(86) PCT No.: PCT/FI2012/050571

§ 371 Date: Mar. 7, 2014

Related U.S. Application Data
(60) Provisional application No. 61/495,416, filed on Jun. 10, 2011.

(30) Foreign Application Priority Data
Jun. 10, 2011 (FI) 20115576

(51) Int. Cl. G01N 30/02

(52) U.S. Cl. CPC G01N 30/02
USPC 73/23.35

(57) ABSTRACT

This invention relates to a method for diagnosing a subject's increased risk of progressing to Alzheimer disease by measuring the concentration of a metabolite and comparing them to respective mean concentration of healthy subjects. According to the invention the increased risk of progressing to Alzheimer's disease by a subject with mild cognitive impairment can be diagnosed without invasive technology.

### FIELD OF THE INVENTION

This invention relates to methods of early diagnosing a subject's increased risk of progressing to Alzheimer's disease.

### DESCRIPTION OF RELATED ART

Alzheimer's disease (AD) is a growing challenge to the health care systems and economies of developed countries with millions of patients suffering from this disease and increasing numbers of new cases diagnosed annually with the increasing age of populations. Mild cognitive impairment (MCI) is considered as a transition phase between normal aging and AD. A subject with MCI shows cognitive impairment, primarily in memory functions, yet has preserved activities of daily living and does not fulfill the criteria of AD or any other dementia disorder. MCI confers an increased risk of developing AD, although the state is heterogeneous with several possible outcomes including even improvement back to normal cognition. Recent research has thus concentrated on obtaining biomarkers to identify features that differentiate between those MCI subjects who will develop AD (progressive MCI, P-MCI) from stable MCI (S-MCI) and healthy elderly control subjects.

Publication WO 2003/050528 demonstrates that a decrease in the level of sulfatides in brain tissue or in cerebrospinal fluids is positively correlated with the presence of Alzheimer's disease. However, ideally, the AD biomarkers (1) would reflect the disease-related biological processes and (2) may be measured non-invasively such as a blood test. The molecular markers sensitive to the underlying pathogenic factors would be of high relevance not only to assist early disease detection and diagnosis, but also to subsequently facilitate the disease monitoring and treatment responses. Promising although non-overlapping results have been obtained in two independent plasma proteomics studies aiming to identify potential markers predictive of AD. Metabolomics is a discipline dedicated to the global study of small molecules (i.e., metabolites) in cells, tissues, and biofluids. Concentration changes of specific groups of metabolites may be sensitive to pathogenically relevant factors such as genetic variation, diet, age, immune system status or gut microbiota, and their study may therefore be a powerful tool for characterization of complex phenotypes affected by both genetic and environmental factors. In the past years, technologies have been developed that allow comprehensive and quantitative investigation of a multitude of different metabolites.

Among the metabolites, lipids have received most attention since all amyloid precursor protein (APP) processing proteins are transmembrane proteins. Lipids are major constituents of cell membranes, and their composition is important to maintain membrane fluidity, topology, mobility or activity of membrane bound proteins, and to ensure normal cellular physiology. Investigations of disease-related “lipidome” covering a global profile of structurally and functionally diverse lipids provide an opportunity to pursue accurately and sensitively studies profiling hundreds of molecular lipids in parallel. The so-called lipidomics approach may not only provide information about the disease-related markers, but in addition deliver clues about the mechanisms behind the control of cellular lipid homeostasis.

However, there remains a problem of early diagnosing a subject's risk of progressing to Alzheimer's disease. Preferably the diagnosis should be non-invasive, easy to use and cost effective. This invention meets these needs.

### OBJECTS AND SUMMARY OF THE INVENTION

It is an aim of the invention to provide an easy to use method for early diagnosis of subjects with an increased risk of progressing to Alzheimer's disease. The present invention provides a method which easily and without invasive steps identifies patients in the very early stages of Alzheimer's disease from healthy subjects. Virtually no overlap occurs between values obtained in subjects who are normal as compared to those with early stage Alzheimer's disease.

The aspect of the invention is a method for diagnosing a subject's increased risk of progressing to Alzheimer's disease. According to the invention the method comprises the steps of obtaining a sample from said subject and measuring the concentration of at least one metabolite, wherein changed concentration indicates an increased risk of progressing to AD. Particularly the invention has the steps as defined in the characterizing part of claim 1.

### BRIEF DESCRIPTION OF THE DRAWINGS

FIG. 1. shows the workflow of experiments and analysis described in the experimental part of this application.

FIG. 2. Feasibility of predicting AD, based on concentrations of three metabolites (2,4-dihydroxybutanoic acid, carboxylic acid, PC(16:0/16:0)) in subjects at baseline who were diagnosed with MCI. (A) The characteristics of the model (AUC, OR, RR) independently tested in ⅓ of the sample are shown as mean values (5^{th}, 95^{th} percentiles), based on 2,000 cross-validation runs. (B) Beanplots of the three metabolites included in the model. (C) GC×GC-TOFMS spectra of the two metabolites included in the model. Acc=classification accuracy; AUC=area under the Receiver Operating characteristic (ROC) curve; OR=odds ratio; RR=relative risk.

FIG. 3. Diagnostic performance of β-amyloid1-42 (LiBAM42, red), 2,4-dihydroxybutanoic acid (blue), and both biomarkers together (green).

### DESCRIPTION OF THE PREFERRED EMBODIMENTS

Abbreviations: AA=arachidonic acid; Acc=classification accuracy; AD=Alzheimer's disease; AUC=area under the Receiver Operating characteristic (ROC) curve; CSF=cerebrospinal fluid; DHA=docosahexanoic acid; EPA=eicosapentaenoic acid; ESI=electrospray ionization; GC×GC-TOFMS=two-dimensional gas chromatography coupled to time-of-flight mass spectrometry; lysoPC=lysophosphatidylcholine; MCI=mild cognitive impairment; MS=mass spectrometry; OR=odds ratio; PC=phosphatidylcholine; RR=relative risk; UPLC-MS=Ultra Performance Liquid Chromatography™ coupled to mass spectrometry.

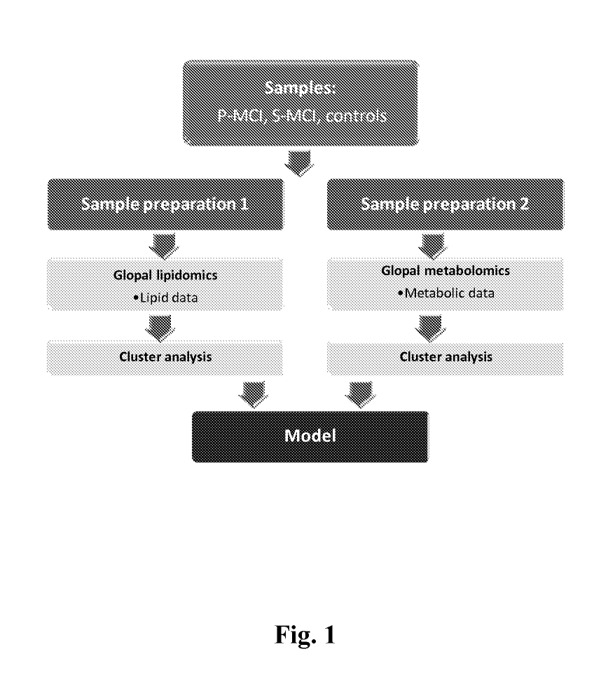

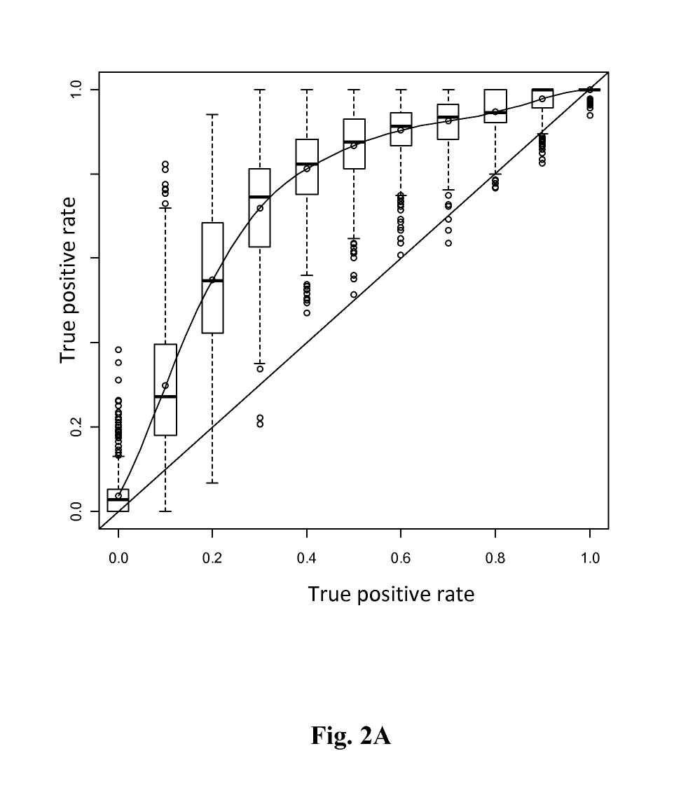

In this study we sought to determine the serum metabolic profiles associated with progression to and diagnosis of Alzheimer's disease in a well characterized prospective study. At the baseline assessment, the subjects enrolled in the study were classified into three diagnostic groups: healthy controls, MCI, and AD. Global metabolomics approach using two platforms with broad analytical coverage, from lipids to hydrophilic metabolites, was applied to analyze baseline serum samples from subjects involved in the study and to associate the metabolite profiles with the diagnosis at baseline and in the follow-up (see FIG. 1). Our findings, based on a well phenotyped population, associate specific metabolic abnormalities with progression to Alzheimer's disease.

According to the invention the increased risk of progressing to Alzheimer's disease by a subject with mild cognitive impairment can be diagnosed without invasive technology. The prognosis is easy and quick, and it does not require sophisticated equipment. The early prediction of risk for progressing of AD allows stratification of patients for more detailed monitoring such as by medical imaging, facilitates development of more efficient pharmacological therapies for the treatment of the disease as well as may initiate the early intervention aimed at disease prevention.

The first embodiment of the invention is a method for diagnosing a subject's increased risk of progressing to Alzheimer disease comprising the steps of:
(a) obtaining a sample from said subject, preferably a biological fluid, and
(b) measuring the concentration of at least one metabolite selected from a group consisting of 2,4-dihydroxy butanoic acid, glycolic acid, 2-hydroxybutyric acid, 3-hydroxybutyric acid, 3-hydroxypropionic acid, glycerate, 3,4-dihydroxybutyric acid and 2-oxoisovaleric acid and their derivatives,
   wherein increased concentration(s) compared to respective mean concentration of healthy subjects indicates an increased risk of progressing to AD.

The above-mentioned metabolites belong to the group of carboxylic acids containing 2 to 5 carbon atoms and one or more hydroxyl or ketone (oxo) groups, in addition to the carboxyl group. Thus, it is preferred to select at least one metabolite from said group. Particularly, the metabolite is selected from such carboxylic acids containing at least two functional groups selected from the hydroxyl and the oxo group.

According to another embodiment of the invention, the metabolite is selected from the following compounds belonging to the above-described group of carboxylic acids:
2,4-dihydroxy butanoic acid,
glycolic acid,
2-hydroxybutyric acid,
3-hydroxybutyric acid,
3-hydroxypropionic acid,
glycerate,
3,4-dihydroxybutyric acid,
2-oxoisovaleric acid,
2,3-dihydroxypropionic acid,
2-hydroxypentanoic acid,
3-hydroxypentanoic acid,
4-hydroxypentanoic acid,
2-hydroxy-4-oxo-pentanoic acid,
5-hydroxy-3-oxo-pentanoic acid,
2,4-dihydroxypentanoic acid,
3,5-dihydroxypentanoic acid,
4,5-dihydroxypentanoic acid,
4-hydroxy-2-oxo-pentanoic acid, and
4,5-dihydroxy-2-oxo-pentanoic acid.

In this connection “a subject” means person with MCI where MCI is defined as mild cognitive impairment and it is considered as a transition phase between normal aging and Alzheimer's disease (AD). MCI confers an increased risk of developing AD, although the state is heterogeneous with several possible outcomes including even improvement back to normal cognition.

In this connection “an increased risk of progressing to AD” means that the risk is statistically significantly increased (is higher) than that of a healthy person. Particularly it means that the ratio of the odds of AD occurring in a group diagnosed, by using the invention, to progress to AD to the odds of it occurring in the group diagnosed not to progress to AD is 4.2, with the 90 percent confidence interval of (1.44, 19.02).

A sample can be any biological fluid, preferably the fluid is blood, serum or plasma.

According to another alternative, the biological fluid is blood, serum, plasma, or urine or cerebrospinal fluid.

Desirably, the biological fluid is first extracted to obtain a suitable metabolic fraction for evaluation of the metabolites of interest. However, depending on the method employed for assessing the level of the metabolite markers, such extraction may not be necessary. The sample ultimately used for the assessment may also be subjected to fractionation procedures to obtain the most convenient ultimate sample for measurement. A particularly preferred and convenient technique of the biological fluid is direct infusion to mass spectrometry, desirable after selective sample extraction.

Methods of measuring metabolite's concentration include, without any restriction, e.g. chromatographic and/or electrophoretic methods combined with mass spectrometry or other spectrometric or electrochemical detector, or MS or other spectrometric or electrochemical detector alone or other biochemical or immunochemical method. The present invention is not limited to the particular methods and components, etc., described herein, as these may vary. It is also to be understood that the terminology used herein is used for the purpose of describing particular embodiments only, and is not intended to limit the scope of the present invention.

As used herein, “level” refers to absolute or semiquantitative concentration or amount of the specific metabolite in given sample from a subject and “comparison” refers to making an assessment of how the proportion, level or concentration of one or more of the given biomarkers in a sample from a subject relates to the proportion, level or concentration of the corresponding one or more biomarkers in a standard or control sample. For example, “comparison” may refer to assessing whether the proportion, level, or concentration of one or more biomarkers in a sample from a subject is the same as, more or less than, or different from the proportion, level, or concentration of the corresponding one or more biomarkers in standard or control sample.

Further embodiments of the invention can be combined with the first embodiment and with each other without restriction. Most of further embodiments discussed below provide means for even better diagnosis compared to diagnosis obtained according to the first embodiment.

In another embodiment the method further comprises a step of measuring the concentration of at least one metabolite selected from a group consisting of PC(16:0/18:1), PC(16:0/20:3), PC(16:0/16:0), PC(18:0/18:1), glycyl-proline, citric acid, aminomalonic acid or lactic acid, wherein increased concentration(s) compared to respective mean concentration(s) of healthy subjects indicates an increased risk of progressing to AD.

In another embodiment the method further comprises step of measuring the concentration of at least one metabolite selected from a group consisting of ribitol, phenylalanine or D-ribose 5-phosphate, wherein decreased concentration(s) compared to respective mean concentration(s) of healthy subjects indicates an increased risk of progressing to AD

In one embodiment a method for diagnosing a subject's risk of progressing to Alzheimer disease comprises the steps of
(a) measuring the level of at least one metabolite selected from a group consisting of 2,4-dihydroxy butanoic acid, glycolic acid, 2-hydroxybutyric acid, 3-hydroxybutyric acid, 3-hydroxypropionic acid, glycerate, 3,4-dihydroxybutyric acid and 2-oxoisovaleric acid and their derivatives, and optionally concentration of one or more metabolite selected from group consisting of PC(16:0/18:1), PC(16:0/20:3), PC(16:0/16:0), PC(18:0/18:1) lipids, glycyl-proline, citric acid, aminomalonic acid and lactic acid or one or more metabolite selected from group consisting of ribitol, phenylalanine or D-ribose 5-phosphate in a biological fluid of said subject;
(b) providing the level of at least one metabolite selected from a group consisting of 2,4-dihydroxy butanoic acid, glycolic acid, 2-hydroxybutyric acid, 3-hydroxybutyric acid, 3-hydroxypropionic acid, glycerate, 3,4-dihydroxybutyric acid and 2-oxoisovaleric acid and their derivatives, and optionally concentration of one or more metabolite selected from group consisting of PC(16:0/18:1), PC(16:0/20:3), PC(16:0/16:0), PC(18:0/18:1) lipids, glycyl-proline, citric acid, aminomalonic acid and lactic acid, or one or more metabolite selected from group consisting of ribitol, phenylalanine or D-ribose 5-phosphate in the corresponding fluid in normal subjects;
(c) comparing the level of metabolite(s) measured in (a) with that of normal subjects as provided in (b)
   wherein when the comparison in (c) shows the level of at least one of said metabolite in said
   subject in (a) is statistically significantly changed from those of normal subjects provided in (b), said subject is identified as a subject with an increased risk of developing Alzheimer's disease.

The ratio of the odds of AD occurring if diagnosed, by using the invention, to progress to AD to the odds of it occurring if diagnosed not to progress to AD is 4.2, with the 90 percent interval of (1.44, 19.02).

In one embodiment further a concentration of a metabolite with spectral fragmentation pattern, after oximation and silylation of the sample extract, and using mass spectrometric detector (MS) with electron impact ionization (EI) [73:998 55:991 75:558 98:355 117:351 57:328 83:271 69:237 54:217 81:203 84:144 132:143 56:133 51:128 129:126 173:121 100:118 67:109 71:105 95:103 113:79 109:74 45:70 105:66 131:59 60:59 49:59 111:58 47:57 61:56 145:53 65:51 146:49 112:49 82:47 64:47 91:46 130:43 118:41 53:41 78:40 85:39 143:38 313:37 107:37 102:36 171:33 97:32 133:31 103:31 68:31 104:30 70:29 135:28 162:25 119:25 187:24 149:24 147:24 74:24 142:23 242:22 269:21 123:21 121:21 87:21 190:20 160:20 66:20 670:19 165:19 144:18 240:17 655:16 581:16 328:16 311:16 172:16 62:16 680:15 309:15 267:15 199:15 185:15 127:15 122:15 108:15 77:15] and with retention index of 2742+/−30, measured in gas chromatographic separation (GC) with 5% phenyl methyl silicone capillary column, is measured.

In another embodiment method further comprises a step of measuring a concentration of one or more of
a metabolite with spectral fragmentation pattern, after oximation and silylation of the sample extract, and using mass spectrometric detector (MS) with electron impact ionization (EI) [73:999, 45:278, 216:152, 57:126, 74:82, 335:82, 75:79, 320:61, 91:28, 174:21, 105:17, 59:14, 115:7, 55:5, 77:2] and with retention index of 2040+/−30, measured in gas chromatographic separation (GC) with 5% phenyl methyl silicone capillary column
a metabolite with spectral fragmentation pattern, after oximation and silylation of the sample extract, and using mass spectrometric detector (MS) with electron impact ionization (EI) [75:996, 73:927, 117:664, 55:455, 129:347, 132:205, 45:197, 67:180, 69:140, 57:137, 81:124, 145:124, 74:99, 47:97, 131:97, 61:76, 83:69, 56:68, 95:66, 76:63, 79:60, 54:57, 96:52, 77:45, 313:45, 118:43, 82:40, 68:39, 84:36, 97:35, 98:31, 53:28, 93:24, 80:22, 109:19, 133:19, 91:7, 72:6, 116:5, 59:4, 110:4, 94:2] and with retention index of 2769.5+/−30, measured in gas chromatographic separation (GC) with 5% phenyl methyl silicone capillary column
a metabolite with spectral fragmentation pattern, after oximation and silylation of the sample extract, and using mass spectrometric detector (MS) with electron impact ionization (EI) [73:948, 174:852, 86:611, 59:409, 45:299, 100:277, 170:171, 175:143, 69:119, 80:77, 53:75, 74:74, 97:67, 176:54, 68:52, 130:50, 58:48, 89:34, 54:30, 55:30, 87:29, 57:26, 126:26, 75:22, 129:20, 139:20, 78:15, 70:13, 60:11, 81:11, 102:11, 56:10, 127:8, 67:7, 83:7, 140:7, 85:6, 171:4, 77:3, 79:3, 91:3, 101:3, 158:3, 46:2, 47:2, 51:2, 72:2, 82:2, 117:2, 50:1, 61:1, 66:1, 84:1, 98:1, 99:1, 112:1, 131:1] and with retention index of 1520.1+/−30, measured in gas chromatographic separation (GC) with 5% phenyl methyl silicone capillary column,
   wherein decreased concentration(s) compared to respective mean concentration(s) of healthy subjects indicates an increased risk of progressing to AD.

In one embodiment a relative change in concentration of measured metabolites is compared. In one embodiment a relative increase of about 10%, preferably 30% or even more for level of at least one of 2,4-dihydroxybutanoic acid, glycolic acid, 2-hydroxybutyric acid, 3-hydroxybutyric acid, 3-hydroxypropionic acid, glycerate, 3,4-dihydroxybutyric acid and 2-oxoisovaleric acid and their derivatives, preferably increase of 2,4-dihydroxybutanoic acid, is indicative for increased risk of progressing to Alzheimer's disease.

In another embodiment a further relative increase of
about 5%, preferably 10% or more of the level of at least one of PC(16:0/18:1), PC(16:0/20:3), PC(16:0/16:0), PC(18:0/18:1), glycyl-proline, citric acid, aminomalonic acid or lactic acid; and optionally
about 10%, preferably about 20% or even more of level for the unidentified carboxylic acid disclosed in this application
   is indicative for increased risk of progressing to Alzheimer's disease.

In this connection “an increased relative concentration” means that the relative response of the metabolite, defined as absolute detector abundance of the given metabolite in relation to the detector abundance of internal standard added to the sample is increased in patients respective to mean responses of healthy subjects.

In another embodiment an increase in absolute concentration is indicative for an increased risk. Absolute values (normal levels) for 2,4 dihydroxybutanoic acid are in a range of approximately 2 to 7 μmol/L and for PC (16:0/16:0) approximately 2 to 10 μmol/L. “An increased absolute concentration” means the concentration of a given metabolite, which is in normal levels on average approximately 4 to 6 μmol/L (2-10 μmol/L) for PC (16:0/16:0) is increased 20% to average levels of 2.5 to 10 μmol/L.

One embodiment of the invention the concentration of at least one metabolite selected from a group consisting of 2,4-dihydroxybutanoic acid, glycolic acid, 2-hydroxybutyric acid, 3-hydroxybutyric acid,3-hydroxypropionic acid, glyceric acid, 3,4-dihydroxybutyric acid and 2-oxoisovaleric acid and their derivatives and at least one metabolite selected from a group consisting of PC(16:0/18:1), PC(16:0/20:3), PC(16:0/16:0), PC(18:0/18:1) lipids, glycyl-proline, citric acid, aminomalonic acid or lactic acid is increased. Increased concentration of at least one metabolite from both groups (in patients respective to mean responses of healthy subjects) is stronger indicator of increased risk.

In a further embodiment also the concentration of the metabolite with spectral fragmentation pattern of the derivatised metabolite using GC-EI/MS: [73:998 55:991 75:558 98:355 117:351 57:328 83:271 69:237 54:217 81:203 84:144 132:143 56:133 51:128 129:126 173:121 100:118 67:109 71:105 95:103 113:79 109:74 45:70 105:66 131:59 60:59 49:59 111:58 47:57 61:56 145:53 65:51 146:49 112:49 82:47 64:47 91:46 130:43 118:41 53:41 78:40 85:39 143:38 313:37 107:37 102:36 171:33 97:32 133:31 103:31 68:31 104:30 70:29 135:28 162:25 119:25 187:24 149:24 147:24 74:24 142:23 242:22 269:21 123:21 121:21 87:21 190:20 160:20 66:20 670:19 165:19 144:18 240:17 655:16 581:16 328:16 311:16 172:16 62:16 680:15 309:15 267:15 199:15 185:15 127:15 122:15 108:15 77:15] and with retention index of 2742+/−30, measured in gas chromatographic separation with 5% phenyl methyl silicone capillary column, is increased. Increase of several indicative metabolites improves the accuracy of prognosis.

In further embodiments the concentration of one or more of metabolite
with spectral fragmentation pattern of the derivatised metabolite using GC-EI/MS: [73:999, 45:278, 216:152, 57:126, 74:82, 335:82, 75:79, 320:61, 91:28, 174:21, 105:17, 59:14, 115:7, 55:5, 77:2] and with retention index of 2040+/−30, measured in gas chromatographic separation with 5% phenyl methyl silicone capillary column
with spectral fragmentation pattern of the derivatised metabolite using GC-EI/MS: [75:996, 73:927, 117:664, 55:455, 129:347, 132:205, 45:197, 67:180, 69:140, 57:137, 81:124, 145:124, 74:99, 47:97, 131:97, 61:76, 83:69, 56:68, 95:66, 76:63, 79:60, 54:57, 96:52, 77:45, 313:45, 118:43, 82:40, 68:39, 84:36, 97:35, 98:31, 53:28, 93:24, 80:22, 109:19, 133:19, 91:7, 72:6, 116:5, 59:4, 110:4, 94:2] and with retention index of 2769.5+/−30, measured in gas chromatographic separation with 5% phenyl methyl silicone capillary column,
with spectral fragmentation pattern of the derivatised metabolite using GC-EI/MS: [73:948, 174:852, 86:611, 59:409, 45:299, 100:277, 170:171, 175:143, 69:119, 80:77, 53:75, 74:74, 97:67, 176:54, 68:52, 130:50, 58:48, 89:34, 54:30, 55:30, 87:29, 57:26, 126:26, 75:22, 129:20, 139:20, 78:15, 70:13, 60:11, 81:11, 102:11, 56:10, 127:8, 67:7, 83:7, 140:7, 85:6, 171:4, 77:3, 79:3, 91:3, 101:3, 158:3, 46:2, 47:2, 51:2, 72:2, 82:2, 117:2, 50:1, 61:1, 66:1, 84:1, 98:1, 99:1, 112:1, 131:1] and with retention index of 1520.1+/−30, measured in gas chromatographic separation with 5% phenyl methyl silicone capillary column,
   is measured and decrease indicates an increased risk of progressing to Alzheimer's disease.

In one embodiment the concentration of 2,4-dihydroxybutanoic acid is measured. Increase of 2,4-dihydroxybutanoic acid shows a strong correlation with increased risk of progressing to Alzheimer's disease.

In one embodiment the concentration of phosphatidylcholine (16:0/16:0) is measured. Increase of phosphatidylcholine (16:0/16:0) in connection with increased 2,4-dihydroxybutanoic acid further improves the prognosis of Alzheimer's disease.

In further embodiments the concentration of citric acid, phenylalanine and/or glycyl-proline is measured and increase of concentration is a further indicator of increased risk of progressing to AD.

In one embodiment of the invention the concentration of at least one metabolite selected from a group consisting of 2,4-dihydroxy butanoic acid, glycolic acid, 2-hydroxybutyric acid, 3-hydroxybutyric acid,3-hydroxypropionic acid, glycerate,3,4-dihydroxybutyric acid and 2-oxoisovaleric acid and their derivatives is increased at least 5%, preferably at least 10% compared to the base level is indicative to increased risk of progressing to Alzheimer disease.

The invention is illustrated by the following non-limiting examples. It should be understood, however, that the embodiments given in the description above and in the examples are for illustrative purposes only, and that various changes and modifications are possible within the scope of the invention.

### EXAMPLES

The following examples are put forth so as to provide those of ordinary skill in the art with a complete disclosure and description of how the biomarkers, compositions, devices, and/or methods described and claimed herein are made and evaluated, and are intended to be purely illustrative and are not intended to limit the scope of what the inventors regard as their invention. Efforts have been made to ensure accuracy with respect to numbers (e.g., amounts, temperature, etc.) but some errors and deviations should be accounted for herein. There are several variations and combinations of methodological conditions, e.g., component concentrations, desired solvents, solvent mixtures, temperatures, pressures and other reaction ranges and conditions that can be applied.

Participants

Within the PredictAD project (http://www.predictad.eu/), focusing on predictors of conversion of MCI to clinical AD dementia, 143 subjects diagnosed with MCI were pooled from longitudinal study databases gathered in the University of Kuopio and their findings were compared to those of 46 healthy control subjects and 37 AD patients (1-lanninen et al., 2002, Kivipelto et al., 2001, Pennanen et al., 2004). Descriptive and clinical data of the study groups are presented in Table 1.

TABLE 1
Descriptive statistics of the study population at baseline

| | Control | Stable MCI | Progressive MCI | AD |
|---|---|---|---|---|
| N = 226 | 46 | 91 | 52 | 37 |
| Gender, male/female | 21/25 | 32/59 | 15/37 | 17/20 |
| (%) | (46/54) | (35/65) | (29/71) | (46/54) |
| Age at baseline, years | 71 ± 6 | 72 ± 5 | 71 ± 6 | 75 ± 4* |
| Education, years | 7 ± 2 | 7 ± 2 | 7 ± 3 | 7 ± 3 |
| MMSE | 25.8 ± 2.2 | 24.6 ± 3.0** | 23.7 ± 2.7*** | 20.5 ± 2.9**** |
| Follow-up time, months | 31 ± 17 | 28 ± 16 | 27 ± 18 | |
| APOE ε2/ε3/ε4, % | 0/87/13 | 4/74/22 | 3/59/38^{a} | 0/65/35^{b} |

^{a}chi-square P < 0.001 for ε4 allele against control with odds ratio 4.0 (CI 2.0-8.3) and P < 0.01 against Stable MCI with odds ratio 2.2 (1.3-3.7).
^{b}chi-square P = 0.001 for ε4 allele against control with odds ratio 3.5 (1.6-7.6) and P = 0.02 against Stable MCI with odds ratio 1.9 (1.1-3.5).
*P < 0.01 against control, Stable MCI and Progressive MCI
**P = 0.03 against control
***P < 0.001 against control and P = 0.03 against Stable MCI
****P < 0.001 against control, Stable MCI and Progressive MCI

The healthy control subjects included in this study were volunteers from population-based cohorts and the methods used for the identification of control subjects have been described in previous studies (Hanninen et al., 2002, Kivipelto et al., 2001). They had no history of neurological or psychiatric diseases and showed no impairment in the detailed neuropsychological evaluation.

MCI was diagnosed using the criteria originally proposed by the Mayo Clinic Alzheimer's Disease Research Center (Petersen et al., 1995, Smith et al., 1996). These criteria have later been modified, but at the time this study population was recruited, the MCI criteria required were as follows: (1) memory complaint by patient, family, or physician; (2) normal activities of daily living; (3) normal global cognitive function; (4) objective impairment in memory or in one other area of cognitive function as evident by scores >1.5 S.D. below the age-appropriate mean; (5) Clinical Dementia Rating (CDR) score of 0.5; and (6) absence of dementia. Since the subjects were pooled from different study databases with slightly different neuropsychological test batteries, two scales which were done with all the MCI subjects were selected to describe their cognitive status, MMSE and Clinical Dementia Rating Sum of Boxes (CDR-SB). Although the neuropsychological test battery used to diagnose MCI varied slightly, all the MCI subjects were considered having the amnestic subtype of the syndrome at the time of recruitment.

Diagnosis of AD included evaluation of medical history, physical and neurological examinations performed by a physician, and a detailed neuropsychological evaluation. The severity of the cognitive decline was graded according to the CDR Scale (Berg, 1988). Brain MRI scan, cerebrospinal fluid (CSF) analysis, electrocardiography (EKG), chest radiography, screening for hypertension and depression and blood tests were also performed to exclude other possible pathologies underlying the symptoms. The diagnosis of dementia was based on the criteria of the Diagnostic and Statistical Manual of Mental Disorders, 4th edition (DSM-IV) (American Psychiatric Association, 1994) and the diagnosis of AD on the National Institute of Neurologic and Communicative Disorders and Stroke and Alzheimer's Disease and Related Disorders Association (NINCDS-ADRDA) criteria (McKhann et al., 1984). All the MR images were also read by an experienced neuroradiologist to exclude subjects with severe white matter lesions or other abnormalities. The study subjects with a history of stroke or transient ischemic attack were excluded and accordingly subjects with extensive confluent white matter lesions.

MCI subjects who developed AD during the course of the follow-up were considered as progressive MCI (P-MCI) subjects (n=52) and those whose status remained stable or improved (i.e., those who were later diagnosed as controls) were considered having stable MCI (S-MCI) (n=91). The follow-up time for the P-MCI subjects (27±18 months, Table 1) was set to start at the baseline date and considered completed at the time of AD diagnosis. In the case of S-MCI subjects, the follow-up time (28±16 months, Table 1) was calculated as the time from baseline date to the last available evaluation date. For all subjects MR images were acquired with 1.5 T MRI scan in the Department of Clinical Radiology, Kuopio University Hospital (Julkunen et al., 2009). The APOE genotype of the study subjects was determined by using a standard protocol (Tsukamoto et al., 1993). The APOE allelic distribution within the study groups is presented in Table 1.

Informed written consent was acquired from all the subjects according to the Declaration of Helsinki and the study was approved by the Ethics Committee of Kuopio University Hospital.

The workflow of experiments and analysis is illustrated in FIG. 1.

### Example 1

### Lipidomic Analysis Using UPLC-MS

The serum samples (10 μl) were mixed with 10 μl of 0.9% sodium chloride in Eppendorf tubes, spiked with a standard mixture consisting of 10 lipids (0.2 μg/sample; PC(17:0/0:0), PC(17:0/17:0), PE(17:0/17:0), PG(17:0/17:0), Cer(d18:1/17:0), PS(17:0/17:0), PA(17:0/17:0), MG(17:0/0:0/0:0), DG(17:0/17:0/0:0), TG(17:0/17:0/17:0)) and extracted with 100 μl of chloroform/methanol (2:1). After vortexing (2 min) and standing (1 h) the tubes were centrifuged at 10 000 rpm for 3 min. and 60 μl of the lower organic phase was separated and spiked with a standard mixture containing 3 labelled lipids (0.1 μg/sample; LPC(16:1/0:0-D₃), PC(16:1/16:1-D₆), TG(16:0/16:0/16:0-¹³C3)).

Lipid extracts were analysed in a randomized order on a Waters Q-Tof Premier mass spectrometer combined with an Acquity Ultra Performance LC™ (UPLC; Waters, Milford, Mass.). The column (at 50° C.) was an Acquity UPLC™ BEH C18 1×50 mm with 1.7 μm particles. The solvent system included 1) ultrapure water (1% 1M NH₄Ac, 0.1% HCOOH) and 2) LC-MS grade acetonitrile/isopropanol (5:2, 1% 1M NH₄Ac, 0.1% HCOOH). The gradient started from 65% A/35% B, reached 100% B in 6 min and remained there for the next 7 min. There was a 5 min re-equilibration step before next run. The flow rate was 0.200 ml/min and the injected amount 1.0 μl (Acquity Sample Organizer; Waters, Milford, Mass.). Reserpine was used as the lock spray reference compound. The lipid profiling was carried out using ESI+ mode and the data was collected at mass range of m/z 300-1200 with scan duration of 0.2 sec. The data was processed by using MZmine 2 software (Pluskal et al., 2010) and the lipid identification was based on an internal spectral library.

The global lipidomics methodology platform based on Ultra Performance Liquid Chromatography coupled to Mass Spectrometry (UPLC-MS) covers molecular lipids such as phospholipids, sphingolipids, and neutral lipids (Nygren et al., 2011). The analysis was performed in negative ionization mode (ESI−), thus covering mainly the polar phospholipids; The final dataset consisted of a list of metabolite peaks (identified or unidentified) and their concentrations, calculated using the platform-specific methods, across all samples. All metabolite peaks were included in the data analyses, including the unidentified ones. We reasoned that inclusion of complete data as obtained from the platform best represents the global metabolome, and the unidentified peaks may still be followed-up later on with de novo identification using additional experiments if considered of interest.

Using the analytical platforms, a total of 139 molecular lipids were measured,. The data was then further transferred for cluster analysis.

### Example 2

### Metabolomic Analysis Using GC×GC-TOFMS

Each serum sample (30 μl) was spiked with internal standard (20 μl labeled palmitic acid, c=258 mg/L) and the mixture was then extracted with 400 μl of methanol. After centrifugation the supernatant was evaporated to dryness and the original metabolites were then converted into their methoxime (MEOX) and trimethylsilyl (TMS) derivative(s) by two-step derivatization. First, 25 μl MOX reagent was added to the residue and the mixture was incubated for 60 min at 45° C. Next, 25 μl MSTFA was added and the mixture was incubated for 60 min at 45° C. Finally, retention index standard mixture (n-alkanes) in hexane was added to the mixture.

For the analysis, a Leco Pegasus 4D GC×GC-TOFMS instrument (Leco Corp., St. Joseph, Mich.) equipped with a cryogenic modulator was used. The GC part of the instrument was an Agilent 6890 gas chromatograph (Agilent Technologies, Palo Alto, Calif.), equipped with split/splitless injector. The first-dimension chromatographic column was a 10 m RTX-5 capillary column with an internal diameter of 0.18 mm and a stationary-phase film thickness of 0.20 μm, and the second-dimension chromatographic column was a 1.5 m BPX-50 capillary column with an internal diameter of 100 μm and a film thickness of 0.1 μm. A DPTMS deactivated retention gap (3 m×0.53 mm i.d.) was used in the front of the first column. High-purity helium was used as the carrier gas at a constant pressure mode (39.6 psig). A 5 s separation time was used in the second dimension. The MS spectra was measured at 45-700 amu with 100 spectra/sec. Split injection (1 μl, split ratio 1:20) at 260° C. was used. The temperature program was as follows: the first-dimension column oven ramp began at 50° C. with a 1 min hold after which the temperature was programmed to 295° C. at a rate of 10° C./min and then held at this temperature for 3 min. The second-dimension column temperature was maintained 20° C. higher than the corresponding first-dimension column. The programming rate and hold times were the same for the two columns.

This platform for small polar metabolites based on comprehensive two-dimensional gas chromatography coupled to time-of-flight mass spectrometry (GC×GC-TOFMS) covers small molecules such as amino acids, free fatty acids, keto-acids, various other organic acids, sterols, and sugars (Castillo et al., 2011). Altogether 544 small polar metabolites were detected in the samples. The data was then further transferred for cluster analysis.

### Example 3

### Cluster Analysis

Due to a high degree of co-regulation among the metabolites (Steuer et al., 2003), one cannot assume that all the measured metabolites are independent. The global metabolome was therefore first surveyed by clustering the data into a subset of clusters using the Bayesian model-based clustering (Fraley and Raftery, 2007). Lipidomic platform data was decomposed into 7 (LCs) and the GC×GC-TOFMS based metabolomic data into 6 clusters (MCs), respectively. Description of each cluster and representative metabolites are shown in Table 2. As expected, the division of clusters to a large extent follows different metabolite functional or structural groups. The data were scaled into zero mean and unit variance to obtain metabolite profiles comparable to each other. Bayesian model-based clustering was applied on the scaled data to group lipids which were similarly expressed across all samples. The analyses were performed using MCLUST (Fraley and Raftery, 2007) method, implemented in R statistical language (Dalgaard, 2004) as package “mclust”. In MCLUST the observed data are viewed as a mixture of several clusters and each cluster comes from a unique probability density function. The number of clusters in the mixture, together with the cluster-specific parameters that constrain the probability distributions, will define a model which can then be compared to others. The clustering process selects the optimal model and determines the data partition accordingly. The number of clusters ranging from 4 to 15 and all available model families were considered in our study. Models were compared using the Bayesian information criterion (BIC) which is an approximation of the marginal likelihood. The best model is the one which gives the largest marginal likelihood of data, i.e., the highest BIC value.

TABLE 2
Metabolome and lipidome cluster descriptions.

| | | | P^{a} | |
|---|---|---|---|---|
| Cluster | Cluster | | Baseline | |
| name | size | Cluster description | diagnosis | Examples of metabolites |
| LC1 | 14 | PCs containing linoleic | 0.0345 | PC(16:0/18:2), PC(18:0/18:2) |
| | | acid (C18:2n6) | | |
| LC2 | 10 | LysoPCs | 0.9365 | lysoPC(16:0), lysoPC(18:0) |
| LC3 | 31 | Palmitate and stearate | 0.0188 | PC(16:0/18:1), PC(16:0/20:3), |
| | | containing PCs | | PC(16:0/16:0), PC(18:0/18:1) |
| LC4 | 29 | Ether PCs | 0.0135 | PC(O-18:1/16:0), PC(O-18:1/18:2) |
| LC5 | 6 | AA containing PCs and | 0.1190 | PC(16:0/20:4), PC(18:0/20:4), |
| | | PEs | | PE(18:0/20:4) |
| LC6 | 13 | EPA and DHA containing | 0.2776 | PC(16:0/22:6), PC(18:0/22:6), |
| | | PCs | | PC16:0/20:5) |
| LC7 | 32 | Sphingomyelins | 0.1106 | SM(d18:1/24:1), SM(d18:1/16:0) |
| MC1 | 176 | Diverse, including free | 0.5900 | 2-ketobutyric acid, citric acid, |
| | | fatty acids, TCA cycle | | succinic acid, myristic acid, stearic |
| | | metabolites | | acid, oleic acid, threonic acid |
| MC2 | 299 | Diverse, including amino | 0.2693 | Cholesterol, sitosterol, campesterol, |
| | | acids, sterols | | lactic acid, pyruvic acid, glycine |
| MC3 | 31 | Amino acids, ketoacids | 0.0516 | Ketovaline, glutamine, ornithine |
| MC4 | 3 | Branched chain amino | 0.5491 | Valine, leucine, isoleucine |
| | | acids | | |
| MC5 | 32 | Diverse | 0.2169 | Histamine, pyroglutamic acid, |
| | | | | glutamic acid |
| MC6 | 3 | Unknown | 0.1392 | |

^{a}ANOVA across the Control, MCI, and AD diagnostic groups at baseline.
Abbreviations: AA, arachidonic acid; DHA, docosahexanoic acid; EPA, eicosapentanoic acid; lysoPC, lysophosphatidylcholine; PC, phosphatidylcholine.

### Example 4

### Descriptive Statistical Analyses

Statistical analyses for clinical data were performed by SPSS software release 14.0.1 for Windows (SPSS Inc; Chicago, Ill.). The comparisons between the different study groups were done by independent samples t-test. Otherwise, if the assumptions for normality were not met, the nonparametric tests were used. For the categorical data, the comparisons between different groups were made with chi-square tests.

One-way Analysis of Variance (ANOVA), implemented in Matlab (MathWorks, Natick, Mass.), was applied to compare the average within-cluster metabolite profiles between the diagnostic groups. The statistical analyses at individual metabolite level were performed using R. The median values of metabolites across the three diagnostic groups at baseline were compared using the KruskalWallis one-way analysis of variance, while the medians of P-MCI and S-MCI groups were compared by Wilcoxon test. Individual metabolite levels were visualized using the beanplots (Kampstra, 2008), implemented in “beanplot” R package. Beanplot provides information on the mean metabolite level within each group, density of the data-point distribution as well as shows individual data points.

### Example 5

### Diagnostic Model

The best marker combination was searched for in two phases: in the first phase penalized generalized linear models (Friedman et al., 2010) were used to pre-screen a prominent marker set and in the second phase a stepwise optimization algorithm was used to optimize the marker combination. In both phases 1000 cross-validation runs were performed. In each run, ⅔ and ⅓ of samples were selected at random to the training and test sets, respectively. In the first phase, markers leading to lowest CV-errors were selected. In the second phase logistic regression model implemented in R was applied to discriminate the groups of interest. The best marker combination in the logistic regression model was selected by stepwise algorithm using Akaike's information criterion (Yamashita et al., 2007). The best model was then applied to the test set samples to calculate their predicted classes. The optimal marker combinations in each of the cross-validation runs, receiver operating characteristic (ROC) curves with area under the curve (AUC) statistics, odds-ratios and relative risks were recorded. Different biomarker signatures were then compared based on the number of times they were selected as the best performing models. The performance of the top ranking signature was then reported using the same procedure as above, but only considering the selected combination of metabolites. Receiver operating characteristic (ROC) curves with area under the curve (AUC) statistics, prediction accuracy, odds-ratios and relative risks were recorded based on performance in the independently tested data (⅓ of samples) for each of the 2000 cross-validation runs.

We investigated the feasibility of prediction of AD, by comparing stable and progressive MCI groups based on metabolomics profiles at baseline. To assess the feasibility prediction of AD, we selected top ranking metabolites based on comparing AD and control groups at baseline from each of the clusters, and performed a model selection in multiple-cross validation runs. The reason for such initial metabolite selection was that clusters already represent to some degree groups of closely associated metabolites.

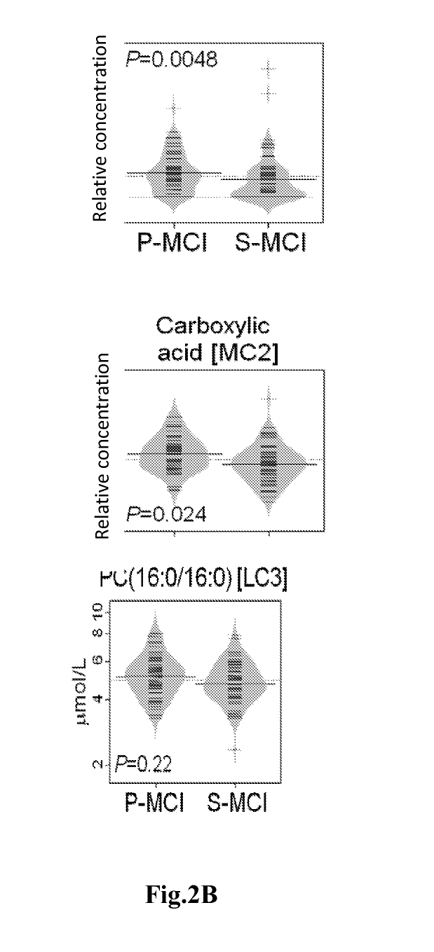

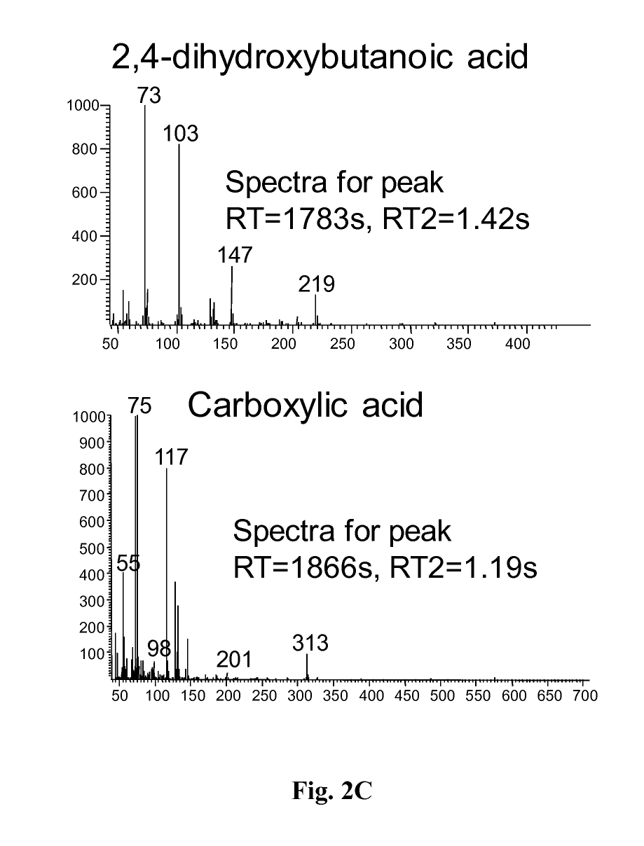

The best model contained three metabolites: PC from LC3 (PC(16:0/16:0)), carboxylic acid (MC2) and 2,4-dihydroxybutanoic acid (MC1; PubChem CID 192742). The top model was selected in 195 out of 1000 cross-validation runs. Other best-selected models contained the two metabolites (carboxylic acid and 2,4-dihydroxybutanoic acid), but with varying lipids (including lysoPC(16:0), PC(16:0/20:5), PC(18:0/20:4) or PC(O-18:1/16:0)), or without. FIG. 2 shows the summary of the combined 3-metabolite diagnostic model, based on the independently tested data taken from 2000 samplings.

A metabolite biomarker signature was identified which was predictive of progression to AD (FIG. 2). The major contributing metabolite in the marker panel separating P-MCI and S-MCI patients was 2,4-dihydroxybutanoic acid. Interestingly, this organic acid is a major component of CSF (Hoffmann et al., 1993, Stoop et al., 2010) but is found in plasma at nearly two orders of magnitude lower concentrations as in CSF (Hoffmann et al., 1993).

Very scarce data is available on biochemistry of 2,4-dihydroxybutanoic acid. In one report, this metabolite was overproduced under low oxygen conditions from D-galacturonic acid (Niemelä and Sjöström, 1985), an uric acid which is a stereoisomer of glucoronic acid. Glucoronic acid was diminished at a marginal significance level in the P-MCI group in our study (P=0.10). In support of this interpretation, there were significant differences in the pentose phosphate pathway as shown by pathway analysis, including diminishment of ribose-5-phosphate and increase of lactic acid, an end product of glycolysis. It is know that under hypoxic conditions in the brain more glucose is metabolized via the pentose phosphate pathway (Hakim et al., 1976). Studies in APP23 transgenic mice have in fact shown that hypoxia facilitates progression to Alzheimer's disease (Sun et al., 2006).

### Example 6

### Metabolomics Analysis in Cerebrospinal Fluid

The GC×GC-TOFMS platform was also applied to analyze the cerebrospinal fluid (CSF) samples, from a subset of patients included in serum metabolomics study (Table 1). Two groups were compared: (1) Control group—controls and stable MCI combined (N=26), and (2) AD group—AD and progressive MCI (n=40). Our study confirmed that some of the metabolites associated with AD as measured in blood are also present in CSF. Furthermore, 2,4-dihidroxybutanoic acid was found significantly upregulated in the AD group (P<0.05), indicating that elevated serum levels of this metabolite may reflect changes of 2,4-dihidroxybutanoic acid metabolism in the brain.

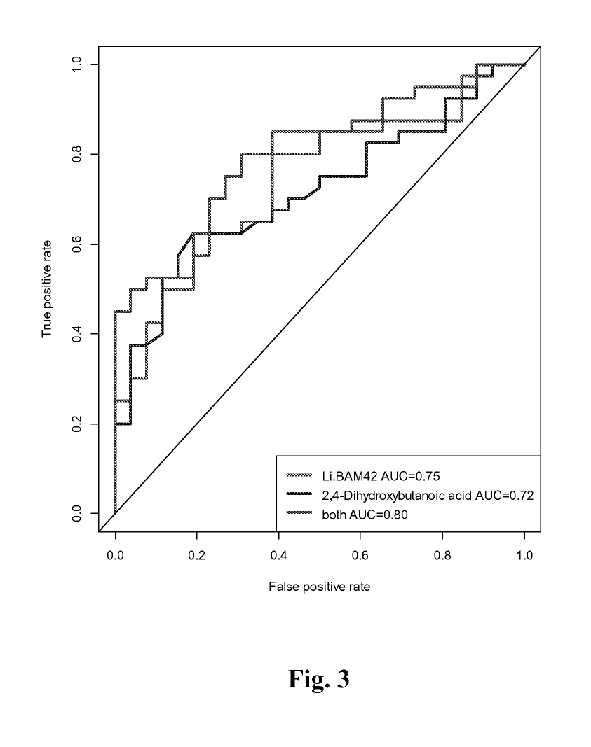

Established CSF markers of AD, β-amyloid1-42 (Aβ42), total tau protein (T-tau), and tau phosphorylated at position threonine 181 (P-tau), were also measured. Among these, only Aβ42 was significantly downregulated in the AD group (P<0.05). However, CSF profiles of Aβ42 and 2,4-dihidroxybutanoic acid were not correlated. Both biomarkers produced similar diagnostic models when applied alone, but the model was significantly improved (AUC=0.80) when Aβ42 and 2,4-dihidroxybutanoic acid were combined (FIG. 3). The association of 2,4-dihidroxybutanoic acid with AD in CSF indicates that the metabolite is involved in AD pathophysiology.

### REFERENCES

American Psychiatric Association. Diagnostic and statistical manual of mental disorders. 4th ed: American Psychiatric Association; 1994.

Castillo S, Mattila I, Miettinen J, Ore\check{s}i\check{c} M, Hyötyläinen T. Data analysis tool for comprehensive two-dimensional gas chromatography-time of flight mass spectrometry Anal Chem. 2011;83(8):3058-67.

Dalgaard P. Introductory Statistics with R. New York: Springer Verlag; 2004.

Fraley C, Raftery A E. Model-based methods of classification: Using the mclust software in chemometrics. J Stat Soft. 2007;18(6):1-13.

Friedman J, Hastie T, Tibshirani R. Regularization paths for generalized linear models via coordinate descent. J Stat Softw. 2010;33(1):1-22.

Hakim A M, Moss G, Gollomp S M. The effect of hypoxia on the pentose phosphate pathway in brain. J Neurochem. 1976;26(4):683-8.

Hoffmann G F, Meier-Augenstein W, Stockler S, Surtees R, Rating D, Nyhan W L. Physiology and pathophysiology of organic acids in cerebrospinal fluid. J Inherit Metab Dis. 1993;16(4):648-69.

Hänninen T, Hallikainen M, Tuomainen S, Vanhanen M, Soininen H. Prevalence of mild cognitive impairment: a population-based study in elderly subjects. Acta Neurol Scand. 2002;106(3):148-54.

Julkunen V, Niskanen E, Muehlboeck S, Pihlajamaki M, Kononen M, Hallikainen M, et al. Cortical thickness analysis to detect progressive mild cognitive impairment: a reference to Alzheimer's disease. Dement Geriatr Cogn Disord. 2009;28(5):404-12.

Kampstra P. Beanplot: a boxplot alternative for visual comparison of distributions. J Stat Soft. 2008;28(Code Snippet 1):1-9.

Kivipelto M, Helkala E L, Hänninen T, Laakso M P, Hallikainen M, Alhainen K, et al. Midlife vascular risk factors and late-life mild cognitive impairment: A population-based study. Neurology. 2001;56(12):1683-9.

McKhann G, Drachman D, Folstein M, Katzman R, Price D, Stadlan E M. Clinical diagnosis of Alzheimer's disease: report of the NINCDS-ADRDA Work Group under the auspices of Department of Health and Human Services Task Force on Alzheimer's Disease. Neurology. 1984;34(7):939-44.

Niemelä K, Sjöström E. Non-oxidative and oxidative degradation of D-galacturonic acid with alkali. Carbohydrate Res. 1985;144:93-9.

Nygren H, Seppanen-Laakso T, Castillo S, Hyotylainen T, Oresic M. Liquid Chromatography-Mass Spectrometry (LC-MS)-Based Lipidomics for Studies of Body Fluids and Tissues. Methods Mol Biol. 2011;708:247-57.

Pennanen C, Kivipelto M, Tuomainen S, Hartikainen P, Hanninen T, Laakso M P, et al. Hippocampus and entorhinal cortex in mild cognitive impairment and early AD. Neurobiol Aging. 2004;25(3):303-10.

Petersen R C, Smith G E, Ivnik R J, Tangalos E G, Schaid D J, Thibodeau S N, et al. Apolipoprotein E status as a predictor of the development of Alzheimer's disease in memory-impaired individuals. JAMA. 1995;273(16):1274-8.

Pluskal T, Castillo S, Villar-Briones A, Oresic M. MZmine 2: Modular framework for processing, visualizing, and analyzing mass spectrometry-based molecular profile data. BMC Bioinformatics. 2010;11(1):395.

Smith G E, Petersen R C, Parisi J E, Ivnik R J, Kokmen E, Tangalos E G, et al. Definition, course, and outcome of mild cognitive impairment. Aging Neuropsychol Cogn. 1996;3(2):141-7.

Steuer R, Kurths J, Fiehn O, Weckwerth W. Observing and interpreting correlations in metabolomic networks. Bioinformatics. 2003;19(8):1019-26.

Stoop M P, Coulier L, Rosenling T, Shi S, Smolinska A M, Buydens L, et al. Quantitative proteomics and metabolomics analysis of normal human cerebrospinal fluid samples. Mol Cell Proteomics. 2010;9(9):2063-75.

Sun X, He G, Qing H, Zhou W, Dobie F, Cai F, et al. Hypoxia facilitates Alzheimer's disease pathogenesis by up-regulating BACE1 gene expression. Proc Natl Acad Sci USA. 2006;103(49):18727-32.

Tsukamoto K, Watanabe T, Matsushima T, Kinoshita M, Kato H, Hashimoto Y, et al. Determination by PCR-RFLP of apo E genotype in a Japanese population. J Lab Clin Med. 1993;121(4):598-602.

Yamashita T, Yamashita K, Kamimura R. A stepwise AIC method for variable selection in linear regression. Commun Stat Theory Methods. 2007;36(13):2395-403.

1. A method for diagnosing a subject's increased risk of progressing to Alzheimer disease comprising the steps of:
(a) obtaining a fluid biological sample from said subject, and
(b) measuring the concentration of at least one metabolite selected from a group consisting of 2,4-dihydroxybutanoic acid, glycolic acid, 2-hydroxybutyric acid, 3-hydroxybutyric acid, 3-hydroxypropionic acid, glycerate, 3,4-dihydroxybutyric acid and 2-oxoisovaleric acid and their derivatives,
wherein increased concentration(s) compared to respective mean concentration of healthy subjects indicates an increased risk of progressing to AD.

2. The method of claim 1, further comprising the step of measuring the concentration of at least one metabolite selected from a group consisting of PC(16:0/18:1), PC(16:0/20:3), PC(16:0/16:0), PC(18:0/18:1), glycyl-proline, citric acid, aminomalonic acid and lactic acid, wherein increased concentration(s) compared to respective mean concentration of healthy subjects indicates an increased risk of progressing to AD.

3. The method of claim 1, further comprising the step of measuring the concentration of at least one metabolite selected from a group consisting of ribitol, phenylalanine and D-ribose 5-phosphate, wherein decreased concentration(s) compared to respective mean concentration of healthy subjects indicates an increased risk of progressing to AD.

4. The method of claim 1, further comprising a step of measuring a concentration of a metabolite with spectral fragmentation pattern, after oximation and silylation of the sample extract, and using mass spectrometric detector (MS) with electron impact ionization (EI) [73:998 55:991 75:558 98:355 117:351 57:328 83:271 69:237 54:217 81:203 84:144 132:143 56:133 51:128 129:126 173:121 100:118 67:109 71:105 95:103 113:79 109:74 45:70 105:66 131:59 60:59 49:59 111:58 47:57 61:56 145:53 65:51 146:49 112:49 82:47 64:47 91:46 130:43 118:41 53:41 78:40 85:39 143:38 313:37 107:37 102:36 171:33 97:32 133:31 103:31 68:31 104:30 70:29 135:28 162:25 119:25 187:24 149:24 147:24 74:24 142:23 242:22 269:21 123:21 121:21 87:21 190:20 160:20 66:20 670:19 165:19 144:18 240:17 655:16 581:16 328:16 311:16 172:16 62:16 680:15 309:15 267:15 199:15 185:15 127:15 122:15 108:15 77:15] and with retention index of 2742+/−30, measured in gas chromatographic separation (GC) with 5% phenyl methyl silicone capillary column is measured, wherein increased concentration(s) compared to respective mean concentration of healthy subjects indicates an increased risk of progressing to AD.

5. The method of claim 1, further comprising a step of measuring a concentration of a metabolite with spectral fragmentation pattern, after oximation and silylation of the sample extract, and using mass spectrometric detector (MS) with electron impact ionization (EI) [73:999, 45:278, 216:152, 57:126, 74:82, 335:82, 75:79, 320:61, 91:28, 174:21, 105:17, 59:14, 115:7, 55:5, 77:2] and with retention index of 2040+/−30, measured in gas chromatographic separation (GC) with 5% phenyl methyl silicone capillary column is measured, wherein decreased concentration(s) compared to respective mean concentration of healthy subjects indicates an increased risk of progressing to AD.

6. The method of claim 1, further comprising a step of measuring a concentration of a metabolite with spectral fragmentation pattern, after oximation and silylation of the sample extract, and using mass spectrometric detector (MS) with electron impact ionization (EI) [75:996, 73:927, 117:664, 55:455, 129:347, 132:205, 45:197, 67:180, 69:140, 57:137, 81:124, 145:124, 74:99, 47:97, 131:97, 61:76, 83:69, 56:68, 95:66, 76:63, 79:60, 54:57, 96:52, 77:45, 313:45, 118:43, 82:40, 68:39, 84:36, 97:35, 98:31, 53:28, 93:24, 80:22, 109:19, 133:19, 91:7, 72:6, 116:5, 59:4, 110:4, 94:2] and with retention index of 2769.5+/−30, measured in gas chromatographic separation (GC) with 5% phenyl methyl silicone capillary column is measured, wherein decreased concentration(s) compared to respective mean concentration of healthy subjects indicates an increased risk of progressing to AD.

7. The method of claim 1, further comprising a step of measuring a concentration of a metabolite with spectral fragmentation pattern, after oximation and silylation of the sample extract, and using mass spectrometric detector (MS) with electron impact ionization (EI) [73:948, 174:852, 86:611, 59:409, 45:299, 100:277, 170:171, 175:143, 69:119, 80:77, 53:75, 74:74, 97:67, 176:54, 68:52, 130:50, 58:48, 89:34, 54:30, 55:30, 87:29, 57:26, 126:26, 75:22, 129:20, 139:20, 78:15, 70:13, 60:11, 81:11, 102:11, 56:10, 127:8, 67:7, 83:7, 140:7, 85:6, 171:4, 77:3, 79:3, 91:3, 101:3, 158:3, 46:2, 47:2, 51:2, 72:2, 82:2, 117:2, 50:1, 61:1, 66:1, 84:1, 98:1, 99:1, 112:1, 131:1] and with retention index of 1520.1+/−30, measured in gas chromatographic separation (GC) with 5% phenyl methyl silicone capillary column is measured, wherein decreased concentration(s) compared to respective mean concentration of healthy subjects indicates an increased risk of progressing to AD.

8. The method of claim 1, wherein relative change in concentration is compared.

9. The method of claim 1, wherein change in absolute concentration is indicative for an increased risk.

10. The method of claim 1, wherein concentration of at least one metabolite selected from the group consisting of 2,4-dihydroxybutanoic acid, glycolic acid, 2-hydroxybutyric acid, 3-hydroxybutyric acid, 3-hydroxypropionic acid, glyceric acid, 3,4-dihydroxybutyric acid and 2-oxoisovaleric acid and their derivatives and at least one metabolite selected from the group consisting of PC(16:0/18:1), PC(16:0/20:3), PC(16:0/16:0), PC(18:0/18:1), glycyl-proline, citric acid, aminomalonic acid or lactic acid is increased.

11. The method of claim 10, wherein further the concentration of the metabolite with spectral fragmentation pattern of the derivatised metabolite using GC-EI/MS: [73:998 55:991 75:558 98:355 117:351 57:328 83:271 69:237 54:217 81:203 84:144 132:143 56:133 51:128 129:126 173:121 100:118 67:109 71:105 95:103 113:79 109:74 45:70 105:66 131:59 60:59 49:59 111:58 47:57 61:56 145:53 65:51 146:49 112:49 82:47 64:47 91:46 130:43 118:41 53:41 78:40 85:39 143:38 313:37 107:37 102:36 171:33 97:32 133:31 103:31 68:31 104:30 70:29 135:28 162:25 119:25 187:24 149:24 147:24 74:24 142:23 242:22 269:21 123:21 121:21 87:21 190:20 160:20 66:20 670:19 165:19 144:18 240:17 655:16 581:16 328:16 311:16 172:16 62:16 680:15 309:15 267:15 199:15 185:15 127:15 122:15 108:15 77:15] and with retention index of 2742+/−30, measured in gas chromatographic separation with 5% phenyl methyl silicone capillary column, is increased.

12. The method of claim 7, wherein further the concentration of the metabolite with spectral fragmentation pattern of the derivatised metabolite using GC-EI/MS: [73:999, 45:278, 216:152, 57:126, 74:82, 335:82, 75:79, 320:61, 91:28, 174:21, 105:17, 59:14, 115:7, 55:5, 77:2] and with retention index of 2040+/−30, measured in gas chromatographic separation with 5% phenyl methyl silicone capillary column, is decreased.

13. The method of claim 7, wherein further the concentration of the metabolite with spectral fragmentation pattern of the derivatised metabolite using GC-EI/MS: [75:996, 73:927, 117:664, 55:455, 129:347, 132:205, 45:197, 67:180, 69:140, 57:137, 81:124, 145:124, 74:99, 47:97, 131:97, 61:76, 83:69, 56:68, 95:66, 76:63, 79:60, 54:57, 96:52, 77:45, 313:45, 118:43, 82:40, 68:39, 84:36, 97:35, 98:31, 53:28, 93:24, 80:22, 109:19, 133:19, 91:7, 72:6, 116:5, 59:4, 110:4, 94:2] and with retention index of 2769.5+/−30, measured in gas chromatographic separation with 5% phenyl methyl silicone capillary column, is decreased.

14. The method of claim 7, wherein further the concentration of the metabolite with spectral fragmentation pattern of the derivatised metabolite using GC-EI/MS: [73:948, 174:852, 86:611, 59:409, 45:299, 100:277, 170:171, 175:143, 69:119, 80:77, 53:75, 74:74, 97:67, 176:54, 68:52, 130:50, 58:48, 89:34, 54:30, 55:30, 87:29, 57:26, 126:26, 75:22, 129:20, 139:20, 78:15, 70:13, 60:11, 81:11, 102:11, 56:10, 127:8, 67:7, 83:7, 140:7, 85:6, 171:4, 77:3, 79:3, 91:3, 101:3, 158:3, 46:2, 47:2, 51:2, 72:2, 82:2, 117:2, 50:1, 61:1, 66:1, 84:1, 98:1, 99:1, 112:1, 131:1] and with retention index of 1520.1+/−30, measured in gas chromatographic separation with 5% phenyl methyl silicone capillary column, is decreased.

15. The method of claim 1, wherein the concentration of 2,4-dihydroxybutanoic acid is measured.

16. The method of claim 1, wherein the concentration of phosphatidylcholine (16:0/16:0) is measured.

17. The method of claim 1, wherein the concentration of citric acid is measured.

18. The method of claim 1, wherein the concentration of phenylalanine is measured.

19. The method of claim 1, wherein the concentration of glycyl-proline is measured.

20. The method of claim 1, wherein concentration of at least one metabolite selected from a group consisting of 2,4-dihydroxy butanoic acid, glycolic acid, 2-hydroxybutyric acid, 3-hydroxybutyric acid, 3-hydroxypropionic acid, glycerate, citric acid, lactic acid, 3,4-dihydroxybutyric acid and 2-oxoisovaleric acid and their derivatives in increased at least 5% compared to the base level.
